(19) United States
(12) Patent Application Publication
(10) Pub. No.: US 2004/0250208 A1
(43) Pub. Date: Dec. 9, 2004

(54) Enhanced spelling checking system and method therefore

(76) Inventors: Robert Nathan Nelms, Ft. Lauderdale, FL (US); Greg Scott Smith, Ocean Ridge, FL (US)

Correspondence Address: ARNALL GOLDEN GREGORY LLP, Suite 2800, 1201 West Peachtree Street, Atlanta, GA, 30309, US

(21) Appl. No.: 10/455,850

(22) Filed: Jun. 6, 2003

(51) Int. Cl. G06F 15/00

(52) U.S. Cl. 715/533

(57) ABSTRACT

A method for providing an enhanced spelling check during a document editing process uses a contact list (110) and a list of favorite websites (112) and includes the steps of checking terms not only against predefined dictionaries, but also the contact list (110) and the list of favorite websites (112). If a term is not found in the dictionaries or the lists and the word is an electronic mailing address, the user can add the electronic mailing address into the contact list.

### BACKGROUND OF THE INVENTION

1. Field of the Invention

The present invention generally relates to software. More specifically, the present invention relates to a method for providing an enhanced spell checking system for an electronic document editing tool.

2. Description of the Related Art

Modern technologies have helped people to produce better written documents. Many word processors are equipped to perform spelling checks to detect, suggest, and even automatically correct spelling mistakes in an electronic file.

On the other hand, the modern technologies have also made it more difficult for word processors to perform proper spelling checks. This is because so many new technical terms that become part of our daily life. These terms, such as electronic mailing addresses, which until few years back were made absolutely no sense to a person, now are intimately related to our identity. Now, it is common for a person to print on his business card not only his address and telephone number but also his electronic mailing address. These new terms have slowed down the spelling check process and have increased the chances of typographical errors in a document.

### SUMMARY OF THE INVENTION

The present invention is a system and method for spell checking and modifying a contact information database during a document editing process, wherein the spelling check includes comparing a word against the contact information database. The method includes the steps of receiving a selected plurality of fields in the contact information database from a user, wherein each field has a plurality of entries and each entry has at least one text, reading a term from a document, and comparing the term to at least one text in each entry of the selected plurality of fields. If the term does not match any text in the selected plurality of fields, then the method determines if the term is an electronic mailing address. If the term does not match any text in the selected plurality of fields and is not an electronic mailing address, then the method determines if the term is a website address. If the term does not match any text in the selected plurality of fields and is an electronic mailing address, then the method creates an electronic mailing address entry in the contact information database and addes the term into the electronic mailing address entry. If term does not match any text in the selected plurality of fields and is a website address, then the method creates a website address entry in a website address database and addes the term into the website address database.

The invention also suggests alternative electronic mailing addresses when the term resembles a stored electronic mailing address.

In another aspect, the invention is also a method for providing alternative terms during a spell check process for a document, wherein the spelling check process includes comparing a term against the contact information database. The method includes the steps of receiving a selected plurality of fields in the contact information database from a user, wherein each field has a plurality of entries and each entry has at least one text, reading a term from a document, and comparing the term against at least one text in each entry of the selected plurality of fields. If the term does not match any text in the selected plurality of fields, then the matter determines if the term is an electronic mailing address. If the term is an electronic mailing address, then the method compares the term against a field of electronic mailing address. If the term is an electronic mailing address and not in the field of electronic mail address, then the method selects a few closely resembled electronic mailing addresses from the field of electronic mailing address and displays the few closely resembled electronic mailing addresses as the alternative electronic mailing addresses to the user. If the term is not an electronic mailing address, the method determines if the term is a website address. If the term is a website address, then the method compares the term against a field of website address. If the term is an electronic mailing address and not in the field of website address, then the method selects a few closely resembled website addresses from the field of website address and displays the few closely resembled website addresses as alternative website addresses to the user.

Other advantages and features of the present invention will become apparent after review of the hereinafter set forth Brief Description of the Drawings, Detailed Description of the Invention, and the Claims.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is a relationship diagram between several components.

FIG. 2 is a flow chart for a set up process.

FIG. 3 is a flow chart for spelling checking.

FIG. 4 is a flow chart for recognizing an electronic mailing address.

FIG. 5 is a flow chart for grammar checking.

FIG. 6 is a flow chart for an electronic mailing address suggestion process.

FIG. 7 is a flow chart for a website address suggestion process.

FIG. 8 is architecture for a spell checking apparatus.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In this description, like numerals refer to like elements throughout the several views. Traditionally, the spell checker for a word processor checks a term against a standard dictionary. Some enhanced spell checker may checks the term against a customized dictionary in addition to the standard library, and the enhanced spell checker may allow users to insert new terms into this customized dictionary. As the technology evolves, more terms are added to people's life and these terms are saved in different files in a person's computer, and the invention provides a method to enhance spelling check by interfacing effectively with different files used by the person.

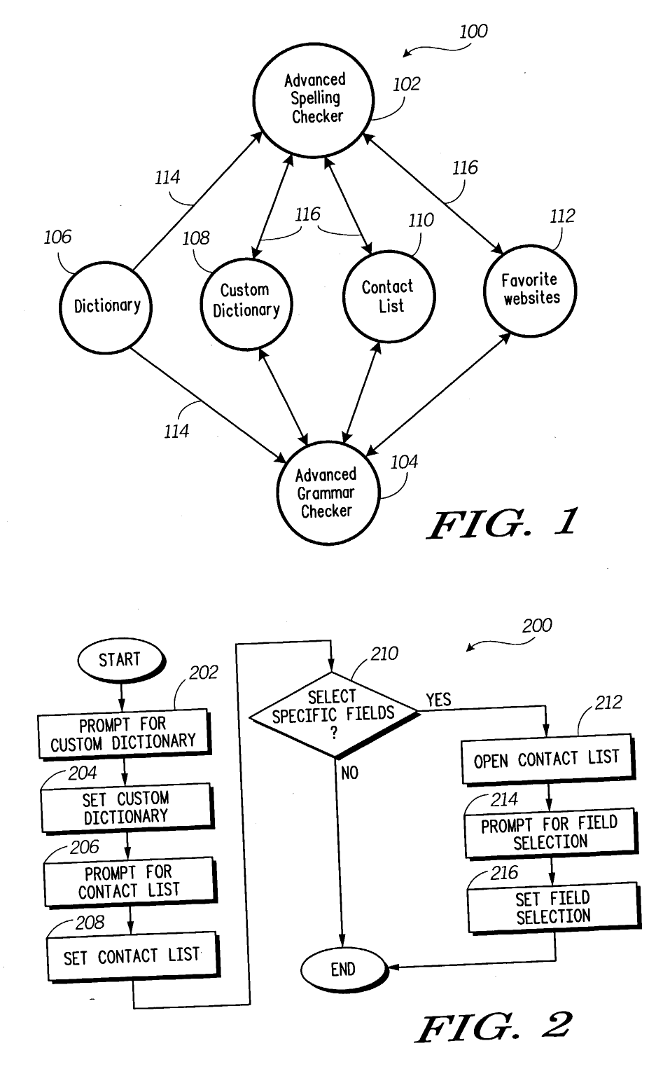

FIG. 1 is a relationship map 100 illustrating an advanced spelling checker 102 and an advanced grammar checker 104 of a word processor and their relationship with a list of information database such as a standard dictionary 106, a customized dictionary 108, a contact list 110, and a list of favorite websites 112. Both the advanced spelling checker 102 and the advanced grammar checker 104 takes information from the dictionary 106, but they do not modify the dictionary 106. This is reflected by a connection line 114 with one arrow indicating the direction of information flow. Both the spelling checker 102 and the grammar checker 104 take information from the custom dictionary 108, the contact list 110, and the list of favorite websites 112 and possibly modify these information sources and this is reflected by the connection lines with arrows on both ends 116. The contact list 110 and the list of favorite websites 112 are samples of various database and files that may be used by the advanced spelling checker 102 and the advanced grammar checker 104. Other files and database may also be used.

FIG. 2 illustrates a set up process 200. The set up process 200 allows a user to select which files or database the advanced spell checker should use. The set up process 200 prompts a user to select a custom dictionary, step 202. The user may select a custom dictionary by using other devices currently available on a computer operating system such as Windows™ or other commercially available operating systems. After receiving the user's selection, the set up process 200 set the custom dictionary, step 204. Alternatively, the user may enter multiple custom dictionaries, and these custom dictionaries are checked sequentially during spelling check. After setting up the custom dictionary, the set up process proceeds to set up the contact list by prompting the user to enter the contact list, step 206. Similarly, the user may enter one or multiple contact list, if he has more than one. The set up process then sets the contact list, step 208.

When selecting a contact list, the user can select one or more fields within the contact list for checking. If the user chooses to select specific fields, the set up process opens the contact list, step 212, and prompts the user for selecting fields, step 216. After the user selects what fields to check, the set up process stores the user's selection, step 216.

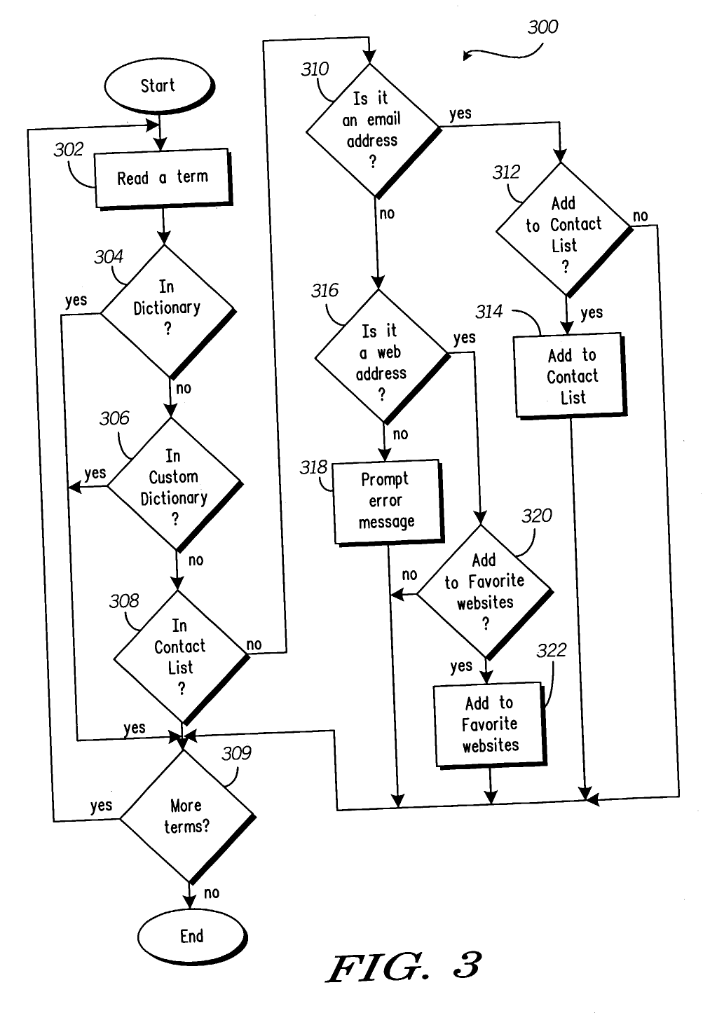

FIG. 3 illustrates a spelling check process 300. The spelling check process reads a term from a document being edited, step 302, checks it against a standard dictionary, step 304. If the term is in the standard dictionary, the spelling check process checks whether there are any additional terms waiting for spelling check, step 309. If there are more terms to check, the process continues back to step 302, and if there is no more terms, then the spelling check process ends.

If the term is not in the standard dictionary, the spelling check process checks whether the term is in the customized dictionary, step 306. If the term is not in the customized dictionary, the spelling check process then checks in the contact list, step 308.

If the term is not in any field in the contact list, the spelling check process checks whether the term is an electronic mailing address, step 310. If the term is an electronic mailing address, the spelling check process prompts the user whether to add the term into the proper category in the contact list, step 312. If the user decides to add the term into the contact list, step 314, an entry in the contact list will be created to store the electronic mailing address represented by the term.

If the term is not an electronic mailing address, the spelling check process continues to check whether the term is a website address, step 316, against the list of favorite website address. If the term is a website address, the spelling check process prompts the user whether to add the term into the list of website address, step 320. If the user decides to add the term into the list of favorite website address, step 322, an entry in the list of favorite website address will be created to store the website address represented by the term. If the term is not a website address either, the spelling check process displays an error message to the user and user may correct the problem by entering another term in its place.

Prompting the user whether to add the electronic mailing address or the website address to the contact list or the list of favorite websites can be done by existing methods supported by different operating systems and also well known to those skill in the art.

Alternatively, the spelling check process may provide a list of closely resembled electronic mailing addresses or website addresses as suggestions for the user to use, as illustrated by FIGS. 6 and 7, and the user may insert the selected website address or the selected electronic mailing address into their respective lists. The selection of the closely resembled suggestions maybe implemented following any of existing methods well known to those skilled in the art.

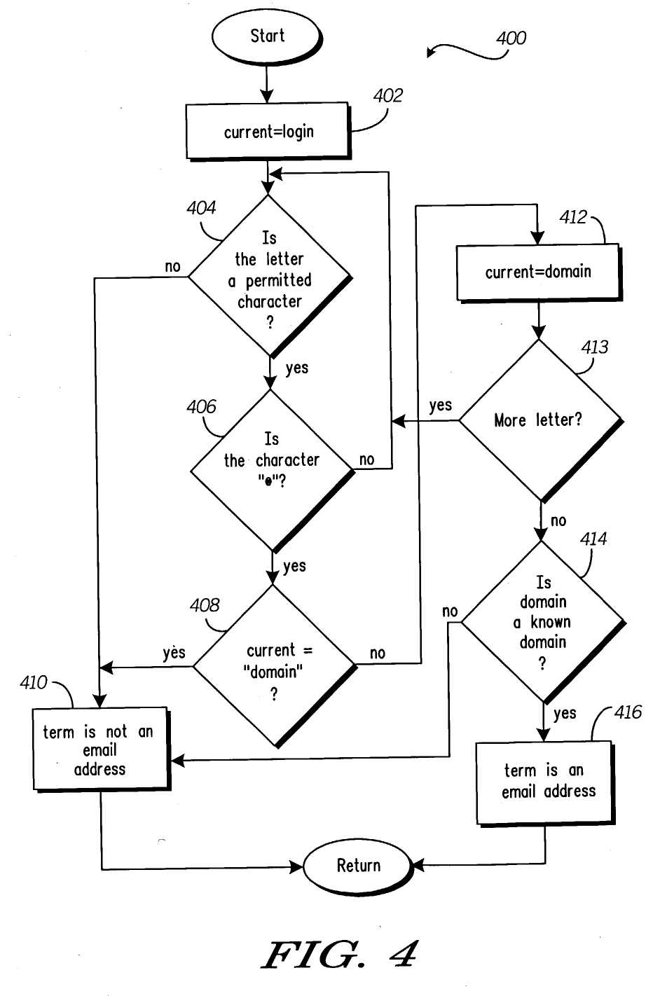

FIG. 4 is a flow chart for an electronic mailing address recognition process 400. When a term is not in the standard dictionary or the customized dictionary, there is a possibility that it may be an electronic mailing address. To recognize the term is an electronic mailing address, the electronic mailing address recognition process must parse the term and check every single letter in the term. The general format of an electronic mailing address is XXXX@YYYY.ZZZ, where XXXX is a login or user identification, YYYY is the unique domain identification, and ZZZ is the domain category. Generally, XXXX, YYYY, and ZZZ can be composed by any number of permitted characters or letters. Typically, certain characters cannot be used, such as “?,” “(,” etc. There is also a list of recognized domain categories and that typically includes “net,” “gov,” “com,” “org,” “us,” “cn,” etc.

The electronic mailing address recognition process 400 starts by setting a variable “current” to “login,” step 402. This variable is used as a flag to indicate whether certain character has been recognized. The process checks every characters in the term whether it is a permitted character, step 404. If the character is an illegal character, then the process indicates the term is not an electronic mailing address and displays an error message, step 410. The process continues to check whether the character is a “@,” which is commonly used in an electronic mailing address to separate the user identification from the unique domain name, step 406. If it is not, then the process continues to check next character, step 404. If the character is “@,” then the process checks whether it is the first “@” by checking if the flag has been set, step 408. If the flag, current, is set to “domain,” it means the current character is a second “@” in the term, which makes it illegal, and the process indicates the term is not an electronic mailing address, step 410.

If the “current” flag has not been set, then the process sets it to “domain,” step 412 to indicate the process starts to check for the unique domain. The process then checks for the next character, step 413, and continues back in step 404.

When there are no more characters, the process checks whether the domain information is a known domain, step 414. The domain is a known domain if it matches one of the approved domains in a list. If the domain is a known domain, the term represents an electronic mailing address, step 416. If the domain is not a known domain, the term does not represent an electronic mailing address, step 410.

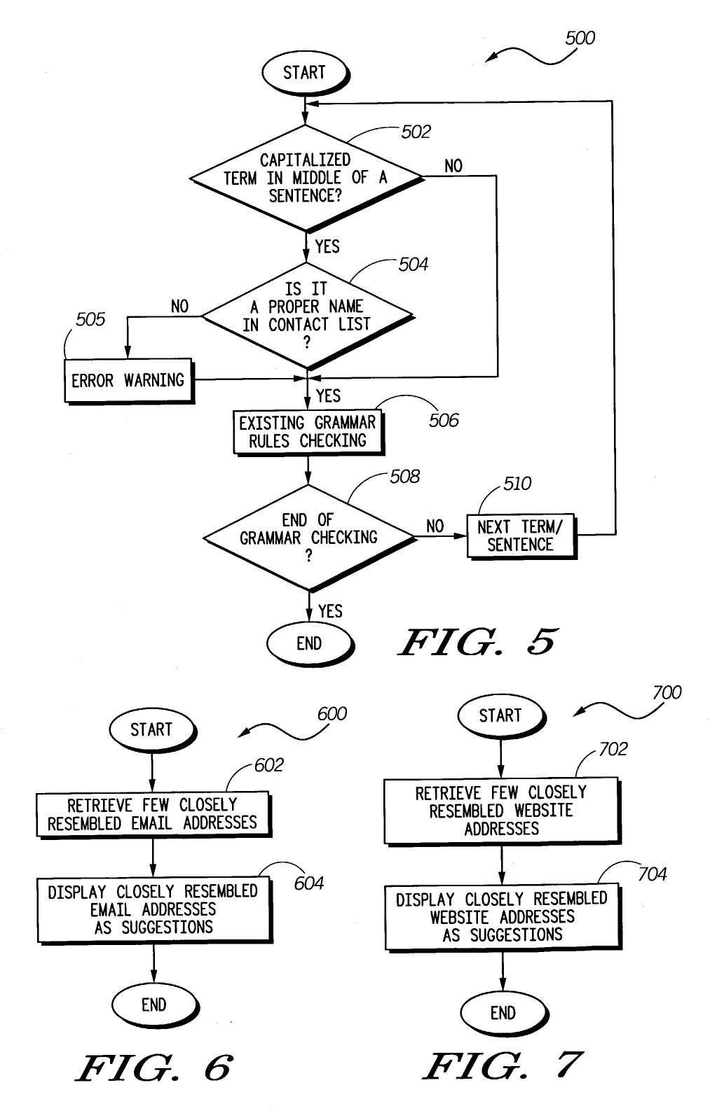

FIG. 5 illustrates a flow chart for a grammar checking process 500. The process 500 checks whether the term in question has a first letter capitalized and located in the middle of a sentence, step 502. If it is not, the process 500 proceeds to other existing rules checking, step 506. If the term in question has a capitalized first letter, the process 500 checks whether the term is a proper name in the contact list, step 504. If the term is a proper name listed in the contact list, then the process 500 proceeds to checking through other existing grammar rules, step 506. If the term is not a proper name listed in the contact list, the process displays an error message, step 505, and proceeds to other rules checking, step 506. After checking through other existing grammar rules, the process checks whether it is the end of grammar checking, step 508. If it is not the end of grammar checking, the process proceeds to next term or sentence, step 510, and restarts the checking process at step 502.

The following is a use scenario for a word processor with an enhanced spell checking and grammar checker according to the invention. The user writes a letter to a client and enters a name of a person, Chung, who is in his contact list, and this person's electronic mailing address, chung@hotmail.com, which is not in the field of electronic mailing address field of the contact list. The electronic mailing address, chung@hotmail.com, is processed by the spelling checker.

Before starting the spelling checker, the user is prompted to selected which database and which fields in the database should be used for spelling check. For example, the user may select his personal contact list and the list of favorite websites from a web browser. Within the contact list, he may select the electronic mailing address field.

After setting proper databases, the spelling checker checks whether the electronic mailing address is a word in the standard dictionary or in a customized dictionary. After failing to find “chung@hotmail.com” in both dictionaries, the spelling checker opens the contact list and checks the electronic mailing address against different fields previously selected by the user. Among the fields selected by the user is the electronic mailing address field. If “chung@hotmail.com” is listed in the electronic mailing address field, the spelling checker verifies it and will not flag it as a term with spelling mistakes.

After failing to find “chung@hotmail.com” in the contact list, the spelling checker checks whether the term is an electronic mailing address. The check is done by parsing the term and checking each and every character in the term. After verifying that the term has only one “@” symbol, no illegal characters, and a domain that is known, the spelling checker acknowledges it as a valid electronic mailing address and not listed in the user's contact list. The spelling checker asks the user whether the term, “chung@hotmail.com” should be added to a new entry in the contact list.

The grammar checker usually flags a capitalized term in middle of a sentence as possible grammatical mistake if the grammar checker fails to realize the capitalized term is a proper name. Generally, a phonetically translated foreign name is not recognized as a proper name and the grammar checker flags it as a possible mistake. The enhanced grammar checker according to the invention prevents unnecessary flagging. The grammar checker reads “Chung” and searches the standard dictionary and the customized dictionary. After failing to find “Chung” in both dictionaries, the grammar checker checks the contact list. Since “Chung” is listed in the user's contact list, the grammar checker verifies it as a proper name and will not flag it as a possible error.

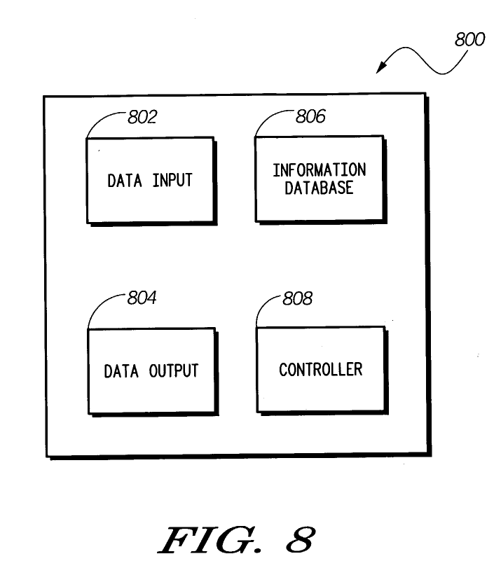

The spell checker according to the invention can be implemented on a variety of physical devices, such as a desktop computer, a text editing machine, an electronic typewriter, a handheld device, etc. FIG. 8 is an illustration of an architecture of a spell checking apparatus 800. The spell checking apparatus 800 includes a data input device 802, a data output device 804, an information database 806, and a controller 808. The data input device 802 may be a keyboard, an audio input port, an electronic data pad, or other suitable devices. The data output device 804 may be a display screen, a printer port, an audio output port, or other suitable devices. The information database 806 may include a standard dictionary file, a customized dictionary file, a contact information file, a preferred websites file, or other data files frequently used by a user. The controller 808 oversees the spell checking operation. The controller 808 reads a term through the data input device 802 and compares it with entries in the information database 806. If the term is not listed in the information database 806, the controller 808 searches for similar terms and presents them as alternatives to the user through the data output device 804.

In view of the method being executable on a computing device, the present invention includes programs resident in a computer readable medium, where the programs direct a server or other computer device having a computer platform to perform the steps of the method. The computer readable medium can be the memory of the server, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In the context of the invention, the method may be implemented, for example, by operating the computing device to execute a sequence of machine-readable instructions. The instructions can reside in various types of signal-bearing or data storage primary, secondary, or tertiary media. The media may comprise, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail maybe made without departing from the spirit and scope of the present invention as set for the in the following claims. Furthermore, although elements of the invention may be described or claimed in the singular, the plural is contemplated unless limitation to the singular is explicitly stated.

What is claimed is:

1. A method for spell checking a document editing process, comprising the steps of:
reading a term from a document;
comparing the term to at least one entry of a selected field in a contact information database; and
indicating the term is an unrecognized term, unless the term matches an entry of the selected field in the contact information database.

2. The method of claim 1, further comprising the steps of:
determining if the term is an electronic mailing address, unless the term matches the at least one entry of the selected field; and
when the term does not match any entry of the selected field and is an electronic mailing address, creating an electronic mailing address entry in the contact information database and adding the term into the electronic mailing address entry.

3. The method of claim 2, wherein the step of determining if the term is an electronic mailing address further comprises the step of checking a domain portion of the term against a list of predefined domains.

4. The method of claim 1, further comprising the steps of:
determining if the term is a website address, unless the term matches the at least one entry of the selected field;
when the term does not match any entry of the selected field and is a website address, creating a website address entry in a website address database and adding the term into the website address entry.

5. The method of claim 4, wherein the step of determining if the term is a website address further comprises the step of checking a domain portion of the term against a list of predefined domains.

6. The method of claim 1, further comprising the step of generating an error message, unless the term is an electronic mailing address or a website address.

7. The method of claim 1, further comprising the steps of:
displaying a plurality of fields from the contact information database to the user; and
in response to displaying a plurality of fields from the contact information database to the user, receiving a selected field from the user.

8. A method for enhancing grammar check during a document editing process, comprising the steps of:
reading a term from a document;
when the term has a first letter capitalized and is not located in the beginning of a sentence in a document, comparing the term against a contact information database; and
displaying an error message, unless the term is in the contact information database.

9. The method of claim 8, wherein the contact information database includes a plurality of proper names.

10. The method of claim 8, further comprising the step of creating an entry in the contact information database and adding the term into the entry, unless the term is in the contact information database.

11. A method for providing alternative terms during a spelling check process for a document, wherein the spelling check process includes comparing a term against the contact information database, comprising the steps of:
reading a term from a document;
determining if the term is an electronic mailing address;
when the term is an electronic mailing address, comparing the term against at least one entry of electronic mailing address in the contact information database; and
when the term is an electronic mailing address and does not match any entry of electronic mail address, selecting a few closely resembled electronic mailing addresses from the contact information database and displaying the few closely resembled electronic mailing addresses as the alternative electronic mailing addresses to the user.

12. The method of claim 11, wherein the step of determining if the term is an electronic mailing address further comprises the step of comparing a domain portion of the term against a list of predefined domains.

13. The method of claim 11, further comprising the steps of:
receiving a selected electronic mailing address selected from the few closely resembled electronic mailing addresses from the user; and
inserting the selected electronic mailing address into the contact information database.

14. The method of claim 11, further comprising the step of generating an error message, unless the term is an electronic mailing address or a website address,.

15. The method of claim 11, further comprising the steps of:
determining if the term is a website address, unless the term is an electronic mailing address;
when the term is a website address, comparing the term against at least one entry of website address in a website address database; and
when the term is a website address and does not match any entry of website address, selecting a few closely resembled website addresses from the website address database and displaying the few closely resembled website addresses as alternative website addresses to the user.

16. The method of claim 15, wherein the step of determining if the term is a website address further comprises the step of comparing a domain portion of the term against a list of predefined domains.

17. The method of claim 15, further comprising the steps of:
receiving a selected website address selected from the few closely resembled website addresses from the user; and
inserting the selected website address into the website address database.

18. An apparatus for spell checking a document, comprising:
a contact information file;
a data input device for receiving a term from a user during a document editing process;
a controller for comparing the term received by the data input device against the contact information file, wherein the controller provides alternative terms to the user unless the term is found in the contact information file; and
a data output device for displaying the alternative terms to the user.

19. The apparatus of claim 18 further comprising a preferred websites file.

20. The apparatus of claim 18, wherein the controller creates a new entry in the contact information file for the term, unless the term is found in the contact information file.
